(19) United States
(12) Patent Application Publication
(10) Pub. No.: US 2023/0229262 A1
(43) Pub. Date: Jul. 20, 2023

(54) Methods of reducing electric fields on mobile phones and capacitive touchscreens

(71) Applicant: John Voccio, West Newton, MA (US)

(72) Inventors: John Peter Voccio, West Newton, MA (US); Kai Ren, Hopkinton, MA (US); Ali Khabari, Westwood, MA (US)

(21) Appl. No.: 17/803,707

(22) Filed: Oct. 21, 2022

Related U.S. Application Data
(60) Provisional application No. 63/270,859, filed on Oct. 22, 2021.

(51) Int. Cl. G06F 3/041; G06F 3/044; H02J 50/00; H02J 50/70; H02J 7/00

(52) U.S. Cl. CPC G06F 3/04182; G06F 3/044; H02J 7/0029; H02J 7/0044; H02J 7/00712; H02J 50/005; H02J 50/70; G06F 2203/04107; H02J 2207/10; H02J 2310/22

(57) ABSTRACT

In part, the disclosure relates to a method of reducing the interaction of mobile phones and capacitive touchscreens with electrically charged aerosols. The method may include reducing electrostatic field from a mobile device using one or more conductive meshes sized to shield a region of a mobile device, wherein the region of the mobile device is an electric field source. Additionally, the method may also include processing signals used to charge the mobile device using one or more of a linear regulator and a signal conditioner to reduce harmonic content of the signals such that the voltage level of signals used to charge the mobile device is less than about 100 V/m RMS, or even more preferably to less than about 20 V/m RMS.

### CROSS-REFERENCE TO RELATED APPLICATIONS

This application claims priority to the U.S. Provisional Pat. Application No. 63/270,859, filed Oct. 22, 2021.

### BACKGROUND

During the course of the SARS Covid-19 pandemic, several avenues of viral transmission were identified, including large droplets, fine aerosols, and surface contamination. Corrective actions, including social distancing, mask-wearing, and sanitization were implemented with some levels of success [1-3]. However, with this and other airborne viruses, transmission in indoor, low-relative humidity environments still poses a challenge [4].

Aerosols generally, as aqueous solutions with dissolved salts, are known to carry electric charge [5]. This may include aerosols laden with viral particles. Therefore, the interactions between electrically charged aerosols and objects that emit electric fields, such as capacitive touchscreens, mobile phones, permanent magnets, and wireless charging pads, especially in indoor environments with low relative humidity, could be another important avenue of study, as these interactions could lead to either accumulation of virus-laded aerosols on the surfaces of these objects or to dispersion and accumulation on nearby surfaces.

### SUMMARY

In part, the disclosure relates to methods and systems for reducing the electric field emanating from mobile phones and capacitive touchscreen display technologies. While these fields are already quite low and certainly within established standards for electrical devices, the methods included in this disclosure are designed to further reduce these fields to minimize the possibility of electrostatic interactions with aerosols, dust and viruses, as this could be a very subtle and non-obvious effect.

The method may include reducing electrostatic field from a mobile device or capacitive touchscreen using one or more conductive meshes sized to shield a region of a mobile device or capacitive touchscreen, wherein the region of the mobile device or capacitive touchscreen is an electric field source. Additionally, the method may also include processing signals used to charge the mobile device or capacitive touchscreen using one or more of a bridge rectifier, linear regulator, and a signal conditioner such that the level of AC electric fields which emanate from the mobile phone or capacitive touchscreen is less than about 100 V/m.

In part, the disclosure relates to a mobile phone wall charger that includes a linear regulator or a signal conditioner to limit the level of AC electric field which emanates from the mobile phone or capacitive touchscreen to less than 100 V/m, wherein the signal regulator is selected from a group consisting of a filter, one or more diodes, a noise conditioner, a resistor, a capacitor, an inductor, and combinations thereof.

In part, the disclosure relates to a mobile phone wall charger that includes a bridge rectifier that includes four or more diodes. In one embodiment, the linear regulator incorporates Zener diodes.

In part, the disclosure relates to a mobile phone wall charger that makes use of true Earth ground in the electric circuit in order to limit the level of AC electric field to less than 100 V/m.

In part, the disclosure relates to a mobile phone case which incorporates a transparent electrostatic film on the front and back surfaces of the mobile phone and which has the primary purpose of minimizing the DC electrostatic charge on the mobile phone while the mobile phone is in an unplugged, non-charging state. In one embodiment, the electrostatic film is selected from the group consisting of a vinyl film, a silica film, a polymer film, a doped film or other films that are generally negative on the triboelectric scale.

In part, the disclosure relates to a conductive Faraday shield which is placed on the back surface of the mobile phone in order to reduce the overall DC electrostatic charge on the mobile phone while the mobile phone is in an unplugged, non-charging state. In one embodiment, the Faraday shield is fabricated from a mesh or sheet selected from the group of conductors consisting of brass, iron, copper, or aluminum.

In part, the disclosure relates to a mobile phone case that includes a conductive Faraday shield made from a conductive mesh or sheet sized to permit wireless charging.

In part, the disclosure relates to a mobile phone case which facilitates a connection between Earth ground and the capacitive touchscreen circuit to reduce the AC electric field to a level below 100 V/m while the mobile phone is being charged either by a mobile phone wall charger or a wireless charging pad.

In part, the disclosure relates to a mobile phone case primarily fabricated from the group of materials known as electrostatic discharge materials.

In part, the disclosure relates to a mobile phone that includes a linear regulator that includes four or more diodes to reduce the harmonic content of the voltage output such that the resulting AC fields in the mobile phone or capacitive touchscreen are less than about 100 V/m.

In part, the disclosure relates to a mobile phone that includes a linear regulator and an output tuning capacitor which tunes the voltage output such that the resulting AC fields in the phone are less than about 100 V/m.

In part, the disclosure relates to a wireless charging pad which incorporates a Faraday enclosure in order to minimize the AC electric fields during charging to less than 100 V/m RMS on the surface of that Faraday enclosure. In one embodiment, the Faraday shield is connected to Earth ground.

In part, the disclosure relates to a mobile phone which incorporates an electric filtering circuit designed to limit the AC electric field on the surface of the mobile phone to less than 100 V/m while the mobile phone is charging on a mobile phone wall charger.

In part, in a more optimized embodiment, this disclosure relates to the aforementioned techniques to further reduce the maximum measured value of AC electric field to less than about 20 V/m RMS measured on the surface of a mobile phone or capacitive touchscreen, which is charging.

Although the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

### PRIOR ART

### Mobile Phone Wall Charger

U.S. Pat. No. 8,912,763 B2
U.S. Pat. No. 9,147,973 B1
U.S. Pat. No. 2004/0204177 A1

U.S. Pat. No. 8,912,763 B2 pertains to a charger device and includes electronic filtering technology. However, we claim that our mobile phone wall charger design is both unique and non-obvious as it has the expressed function of reducing the resulting AC electric field which emanates from the surface of the mobile phone to a value less than 100 V/m RMS.

Furthermore, this above-referenced patent and others cited therein make no reference to adding an Earth-ground plug to the mobile phone wall charger. In this respect, what is novel and non-obvious is that the Earth ground plug may be utilized to improve the performance of the electronic filtering such that the AC electric field emanating from the mobile phone is reduced to a value less than 100 V/m RMS.

Furthermore, it is both novel and non-obvious that the Earth ground connection established by the mobile phone charger plug may be utilized in combination of the charging cable and mobile phone case to connect one or more surfaces of the capacitive touchscreen to Earth ground, thereby minimizing the AC electric field resonance from occurring.

### Mobile Phone Case

US Patent none found

We could not find any prior art that dealt with minimizing electrostatic fields on a mobile phone.

Capacitive touchscreens utilize “excess electrons” on the screen surface to facilitate the location of a human finger, so it is well-known and obvious that there are electrons and, therefore, electrostatic charge on a touchscreen.

Dust accumulates on capacitive touchscreens via electrostatic attraction.

However, it is non-obvious that these screens still work even if the excess electrons are minimized, as the local drop in voltage due to the presence of a human finger still occurs even if some of these excess electrons are neutralized by the electrostatic film.

### Wireless Charging Pad

U.S. Pat. No. 10,027,150 B2

U.S. Pat. No. 10027150B2 references RF/EMI shielding for a wireless charger; however, this is referring to or assuming higher frequency shielding, which is on the order of giga-hertz (GHz), as evidenced by references to using metallic coatings, for example, for shielding. For example, the skin depth for aluminum at 1 GHz is 2.6 microns.

However, for our application, we are trying to shield much lower frequencies in the 50-150 kHz range. For example, to shield 100 kHz with aluminum, the skin depth is 260 microns, which is typically much larger than most plating thicknesses, which are typically only a few microns.

Furthermore, in order to fully-shield a signal, an enclosure needs to be 3-4 skin depths thick, which, in the case of aluminum at 100 kHz, would be ~1000 microns, or 0.040 inches thick.

While this enclosure is similar in concept to that cited in the previously refenced patent, the non-obvious part is that we are trying to shield much lower frequencies.

The idea of using electrical Earth ground to aid in the shielding is also novel and non-obvious.

### BRIEF DESCRIPTION OF THE DRAWINGS

The figures are not necessarily to scale, emphasis instead generally being placed upon illustrative principles. The figures are to be considered illustrative in all aspects and are not intended to limit the disclosure, the scope of which is defined only by the claims.

FIG. 1A is a plot showing typical AC voltage, or ripple, waveform from the output of a laptop computer 5 V USB port. Note that the peak-peak voltage spike has a value of ~0.1 V.

FIG. 1B is a plot showing typical AC voltage, or ripple, waveforms from the output of a mobile phone wall charger. Note that the peak-peak voltage is ~1.0 V, which is an order of magnitude larger than the battery charging case.

FIG. 2A is an exemplary sawtooth waveform from the output of an electrical device charger.

FIG. 2B provides the corresponding Fourier decomposition showing multiple harmonics that are targets for removal using one or more of the devices or methods disclosed herein according to an embodiment of the disclosure.

FIG. 3A is a contour plot showing the AC electric fields (V/m RMS) on the surface of and in the vicinity of a mobile phone charging either in an unplugged, non-charging state or charging using a 5 V battery pack. Note that there is essentially no emanating AC field.

FIG. 3B is a plot showing the AC electric fields (V/m) on the surface of and in the vicinity of a mobile phone charging using a mobile phone wall charger.

FIG. 4 shows a typical waveform for the 100-turn pick-up coil which measures the frequency of the output electric field (V/m) on a mobile phone. Note that the minor frequency is ~50 kHz with a ~500 kHz ripple.

FIG. 5 shows the experimental set-up for studying the interaction between negatively charged aerosols generated by a generic mesh nebulizer and a mobile phone using a strip of moisture-absorbing TeeJet paper.

FIG. 6 provides the configuration of a mobile device with a Faraday shield and electrostatic films added to reduce the overall DC electrostatic charge on the mobile phone according to an embodiment of the disclosure.

FIG. 7A is a photograph showing exemplary data for a low relative humidity (RH ~ 47%) trial using a mesh nebulizer to flow negatively charged aerosols over an Alcatel TracFone mobile phone. The flow direction is from right to left.

FIG. 7B is a photograph showing exemplary data for a low relative humidity (RH ~ 47%) trial using a mesh nebulizer to flow negatively charged aerosols over an LG G Stylo mobile phone. The flow direction is from right to left.

FIG. 7C is a photograph showing exemplary data for a low relative humidity (RH ~ 47%) trial using a mesh nebulizer to flow negatively charged aerosols over an Apple iPhone 8 mobile phone. The flow direction is from right to left.

FIG. 8 is a photograph of the relative humidity comparison (high: RH -60% and low: RH ~ 47%) trial using a mesh nebulizer to flow negatively charged aerosols over an Apple iPhone 8 mobile phone. The flow direction is from right to left.

FIG. 9 shows a mobile phone wall charger which incorporates the Earth ground plug.

FIG. 10 is a circuit diagram of an exemplary mobile phone wall charger that includes a bridge rectifier and a linear regulator configured to reduce the AC electric field emanating from a mobile phone to less than 100 V/m.

FIG. 11 is a circuit diagram of an exemplary mobile phone wall charger that incorporates Zener diodes to regulate the output voltage in order to reduce the AC electric field emanating from a mobile phone to less than 100 V/m.

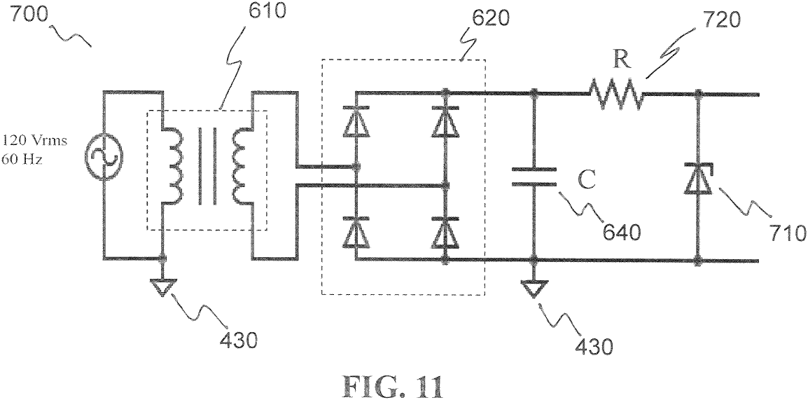

FIG. 12A shows the AC electric field level (V/m RMS) for a wireless charging pad with no phone.

FIG. 12 B shows the AC electric field level (V/m RMS) for a wireless charging pad with a charging phone.

FIG. 13 shows a typical waveform for the 100-turn pick-up coil which measures the frequency of the output electric field (V/m RMS)) on the surface of a mobile phone which is being charged on a wireless charging pad.

FIG. 14 shows a Faraday enclosure, which utilizes electrical Earth grounding, for a wireless charging assembly.

DRAWING NUMBERING AND VOCABULARY

| | | | |
|---|---|---|---|
| 100 | 5 V USB Battery Pack Waveform | 600 | Electrical Circuit 1 |
| 110 | Wall Charger Voltage Waveform | 610 | Transformer |
| 200 | Mobile Phone | 620 | Bridge Rectifier |
| 300 | Mesh Nebulizer | 630 | Linear Regulator |
| 310 | TeeJet Moisture-Sensitive Paper | 640 | Capacitor |
| 320 | Base | 700 | Electrical Circuit 2 |
| 400 | Mobile Phone Wall Charger | 710 | Zener Diodes |
| 410 | 5 V USB Input Port | 720 | Resistor |
| 420 | Earth Ground Plug | 800 | Wireless Charging Pad |
| 430 | Earth Ground Connection | 810 | Faraday Enclosure |
| 500 | Mobile Phone Case | 820 | Earth Ground Shield Connection |
| 510 | Electrostatic Film | | |
| 520 | Faraday Shield | | |

### DETAILED DESCRIPTION

Mobile phones 200, tablets and capacitive touchscreens, in general, are ubiquitous in modern society and in developed and developing nations alike. Various advertising kiosks and signage include many types of electronic display technology. In airports, airplanes, taxis, car services, trains, transportation hubs, and various public places, device users routinely engage in charging their phones and tablets. Phones, tablets, and modern display technologies may use capacitive touchscreens which essentially use parallel-plate capacitor sheets to detect the touch and location of a human finger. These screens are designed to project a DC electrostatic field across the surface of the screen; this technology is called projected capacitance. This projected electric field is altered by the presence of a human finger, which has a higher conductivity than air due to its water content, causing a change in the local capacitance and voltage. Furthermore, time-varying AC electric fields are excited within the device during charging from an AC 120 V, 60 Hz wall power supply.

While there is nothing inherently wrong with capacitive touchscreen technology, there may be very subtle interactions, whereby these AC electric fields interact with overpassing electrically charged aerosols, which may contain viruses, causing accumulation or contamination of nearby surfaces.

In some embodiments, one or more sawtooth-shaped bridge-rectified DC signals may be modified using various devices or signal processing steps to reduce excitation of AC fields and, in turn, reduce the interaction with electrically charged aerosols.

Aerosols generated by human breath are generally negatively charged [1, 2], while dust and viruses are generally positively charged, allowing either to become either attracted or repelled by electrically charged surfaces at low relative humidity (RH), typically RH < 55% [3], where the combination of higher surface resistivities [4] and lower air electrical conductivity gives rise to stronger electrostatic interactions between electrically charged particles, surfaces and devices.

Charged surfaces include capacitive touchscreens which are used in many electronic devices, including touchscreens on mobile phones 200 and tablets. Electrostatic interactions may be enhanced by the AC electric fields generated during phone charging, as other researchers have demonstrated that fine droplets can be agglomerated onto the larger ones through AC electric field-induced collisions, thereby improving the effectiveness of an electrostatic precipitator [5-8].

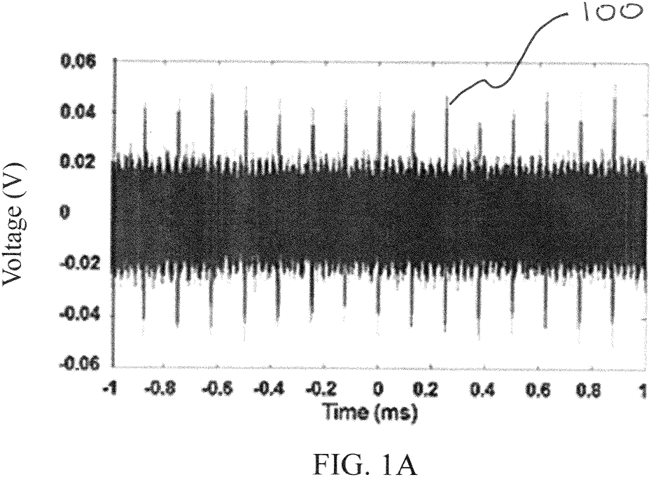

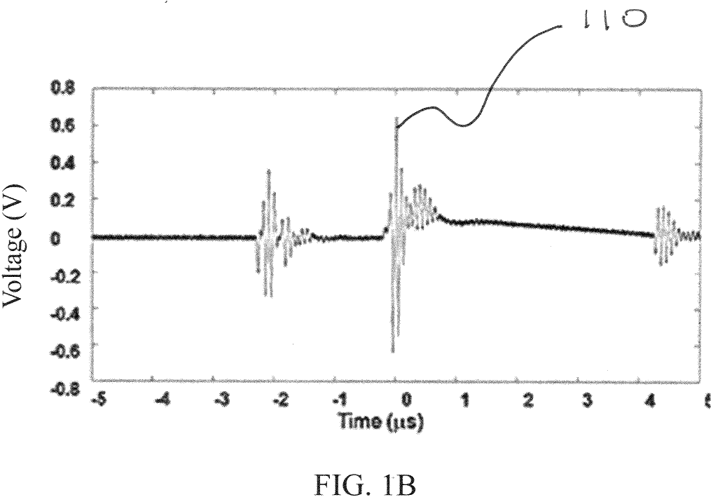

These fields may be generated from the AC-DC bridge rectifier 620 in the mobile phone wall chargers 400 generating a sawtooth-shaped waveform 110 which has higher-order harmonic content as shown in FIG. 1B. In addition, the permanent magnet used in a device’s speaker projects a magnetic field. All of these electric and magnetic fields may interact with electrically charged aerosols and other airborne particles, like dust and viruses, changing their flight paths by electrostatic interactions, such as attraction and repulsion.

In various embodiments, two different types of electric fields were measured—DC electrostatic and AC electric fields. The DC electrostatic fields were expected due to the projected capacitance aspect of a capacitive touchscreen, but the AC electric field was non-obvious. Using a Lascells E-Field Detector (model no. LA 10-990), the DC electrostatic charge was measured to be in the range of 0-100 picocoulombs (pC) on various locations on the surfaces of both an Apple iPhone 8 and an LG G Stylo. The observation of electrostatic charge was further confirmed using a Faraday pail experiment which measured the total electrostatic charge on both phones in the range of around 0 to 1 V using a Pasco Faraday pail (model no. ES-9042-A).

Time-varying AC fields are generated when an AC wall outlet is used to charge the mobile phone 200. The 120 V, 60 Hz AC waveform is converted to an approximate 5 V DC waveform 110 using a bridge rectifier 620 circuit. Referring to FIG. 1B, the resulting DC sawtooth waveform 110 when using a mobile phone wall charger 400 has periodic, abrupt step changes before each decay, whereas the waveform 100 resulting from a 5 V battery pack is more smoothly varying as shown in FIG. 1A.

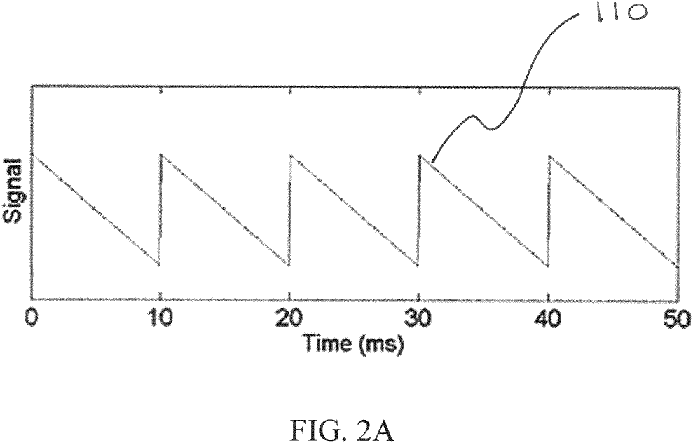

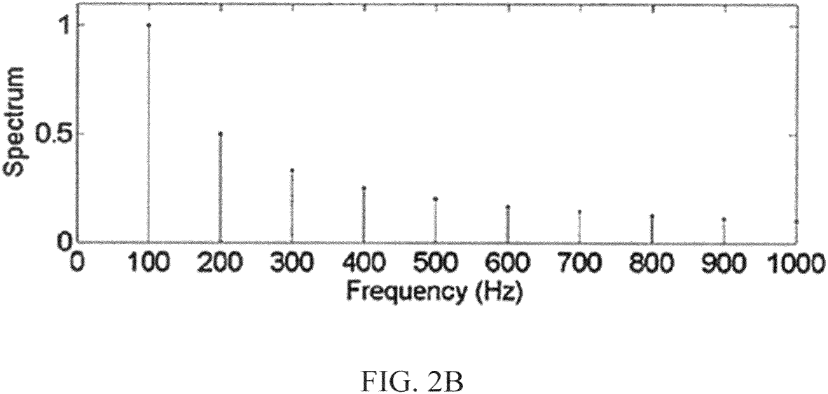

FIG. 2A shows an exemplary sawtooth waveform, such as that shown in the charging profiles of FIG. 1B, in the time domain in FIG. 2A and also in the frequency domain in FIG. 2B. As shown in FIG. 2B, a sawtooth waveform has not only the main fundamental frequency but also higher order harmonics. This higher-order harmonic content can excite one or more electrical circuits of the mobile phone 200, thereby creating AC electric fields which emanate from the surface of the mobile phone 200. These fields could possibly increase the propensity for a mobile phone 200, capacitive touchscreen display, tablet, or other devices propensity to interact with electrically charged aerosols.

Various embodiments of the disclosure modify one or more device mobile phone wall charger 400 waveforms to reduce the emanating AC electric fields, especially in low indoor relative humidity environments, typically below 55% RH, where electrostatic interactions are more likely to occur.

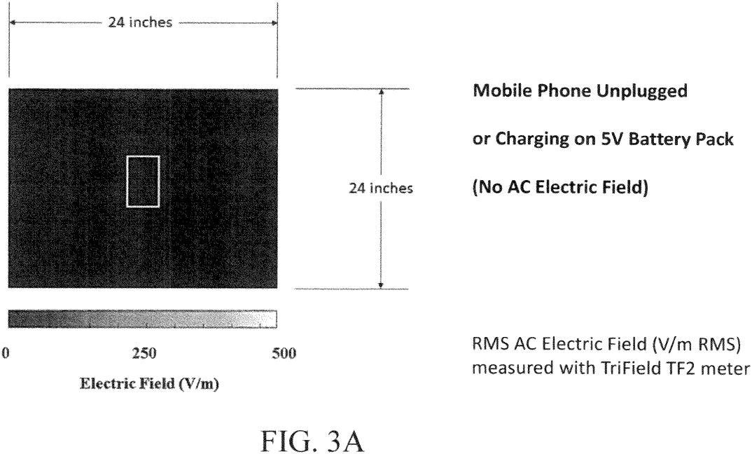

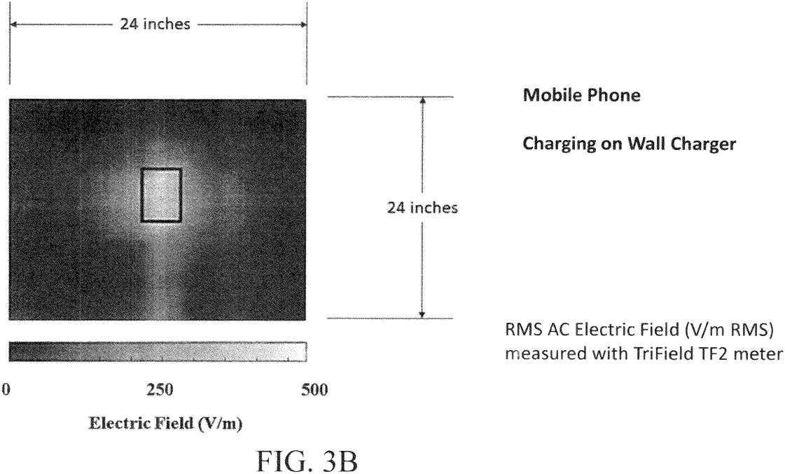

This step change in voltage generates high harmonic content which results in the AC electric and magnetic fields, so-called EMF, which emanate from the surface of the mobile phone 200. These fields were measured using a handheld TriField EMF Meter Model TF2 on the surface of an Apple iPhone 8 while charging on a 5 V battery pack and also on a mobile phone wall charger 400 are shown in FIGS. 3A and 3B, respectively. The measured AC electric fields are virtually zero while charging on a 5 V battery pack, whereas peak values of ~500 V/m RMS are found while charging on a mobile phone wall charger 400. Since the phone has little to no AC electric field in its unplugged, normal state, or while charging on a smooth 5 V battery pack, the design of smoother charging methods is the main focus of this disclosure, as opposed to the design of a mobile phone or capacitive touchscreen itself.

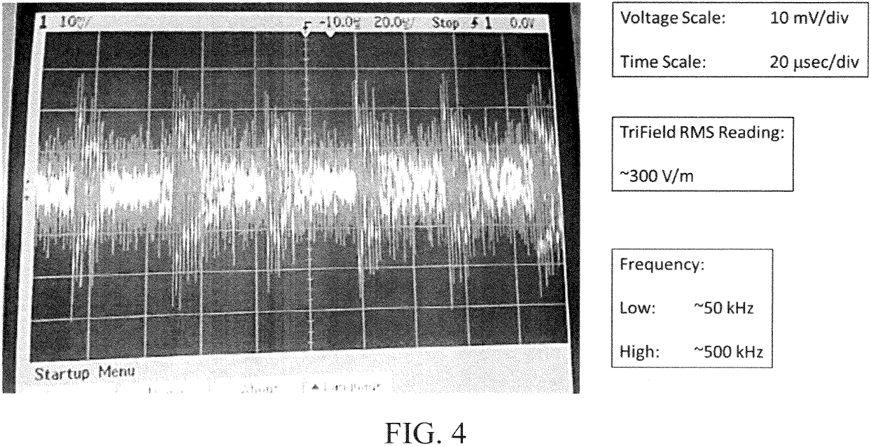

The frequency of these AC electric fields induced by electric charging was measured using a simple 100-turn wire-wound pick-up coil. An oscilloscope trace of the output electric field waveform is provided in FIG. 4, showing a pulse frequency of ~50 kHz with an overriding higher frequency of ~500 kHz typically. These are considered low frequencies in comparison to the expected GHz-level RF frequencies of wireless communication. In addition, the frequency response of the TriField TF2 meter is 40 Hz to 100 kHz, so these frequencies are within the upper portion of the range of this meter.

A simple aerosol experiment was designed and implemented to investigate the aerosol particle-mobile phone 200 interactions qualitatively and comparatively. Mitigating techniques, such as the application of conductive sheets or meshes, shields and electrostatic films 510, were successfully applied.

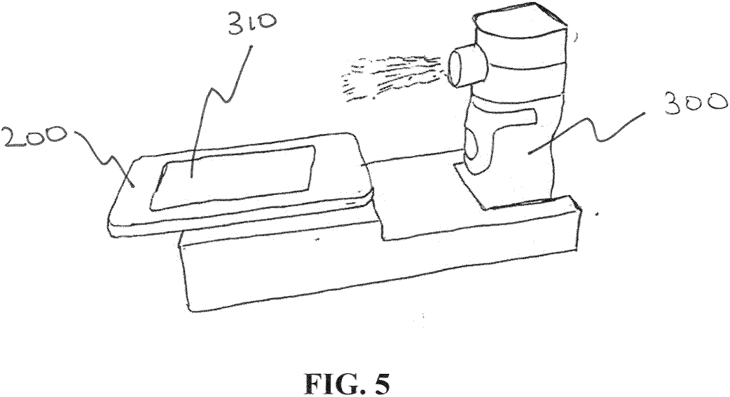

Mesh nebulizers 300 generally make negatively charged aerosols [9]. Negatively charged fine aerosols, typically in the 1 to 5 micron diameter range, were generated using a generic mesh nebulizer 300 as shown in FIG. 5, which has the following specifications: size: 5.1 × 3.8 × 10.5 cm; atomization rate: 0.2 ml/min; particle size: 1-5 µm; and cup capacity: 8 ml maximum.

For each condition (i.e., mobile phone type, charging and shielding) a Plastic Control (or fake dummy mobile phone) piece was run as a comparison, and the nebulizer was run continuously for 10 minutes. This test provides a good qualitative comparison between the various states for a given mobile phone 200.

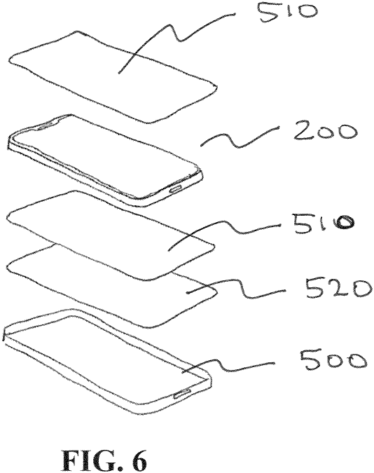

Shielding consisted of adding a conductive, 0.005-inch-thick brass plate, serving as a Faraday shield 520 to the back surface of the mobile phone 200 and a translucent vinyl electrostatic film 510 to both the front and back surfaces of the mobile phone 200. This electrostatic film material was purchased at Staples, and it is sold as repositionable window decal material, such as that used after a typical automobile oil change. This configuration is depicted in FIG. 6. After applying these shielding materials, it was confirmed using the Lascells E-Field meter that the electrostatic field minimized to virtually zero on both the front and back of the mobile phone 200.

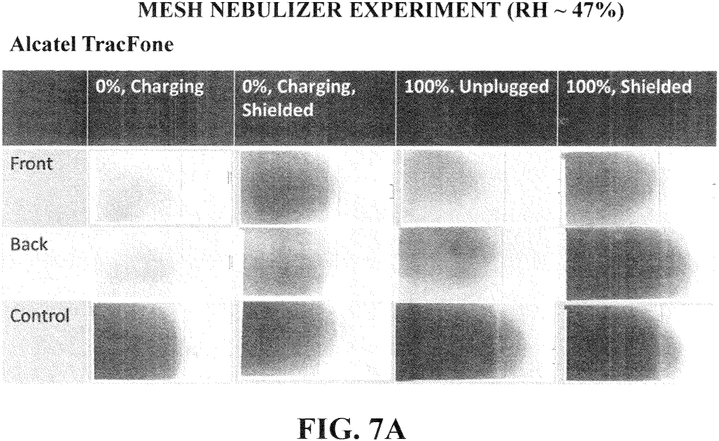

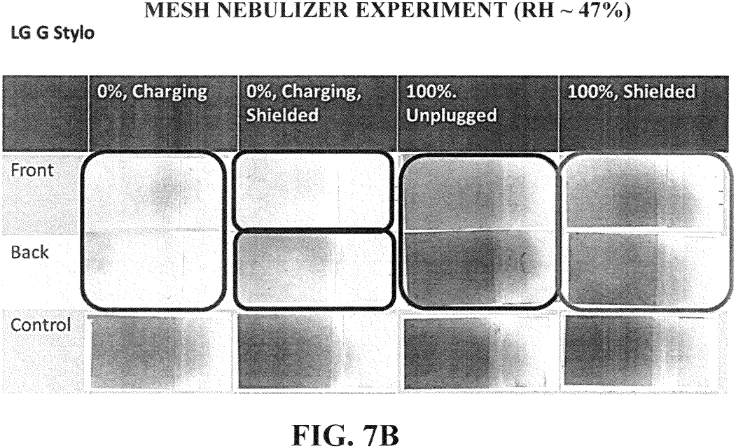

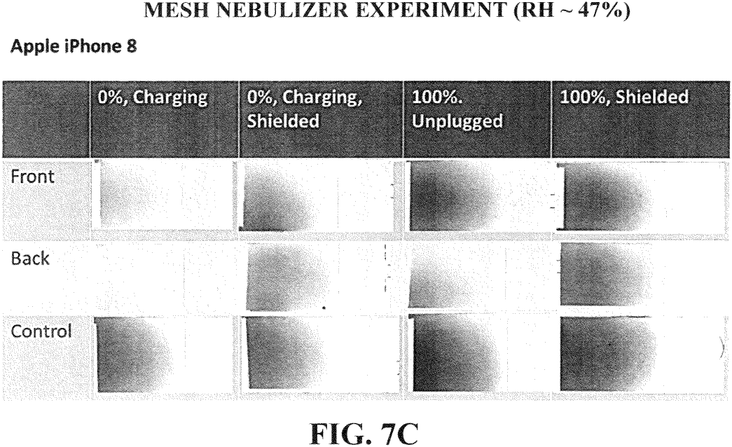

The results of these tests are provided in FIG. 7A, FIG. 7B and FIG. 7C. These tests were all run in a low relative humidity environment of 47 ± 2% RH. In all of these cases, there is less deposition on the moisture-absorbing TeeJet paper 310 when the phones were either in the Charging or Unplugged conditions. This results seems to indicate that, in these states, the phone is behaving like a negatively charged surface, thereby repelling the negatively charged aerosols of the mesh nebulizer 300. The implication is that, if the mobile phone repels negatively charged aerosols, then it could possibly attract positively charged particles.

On the other hand, the Fully-Shielded phone behaves very similarly to the Plastic Control phone, indicating that the shielding is effectively cancelling the electrostatic charge, which was previously confirmed with the Lascells E-Field meter.

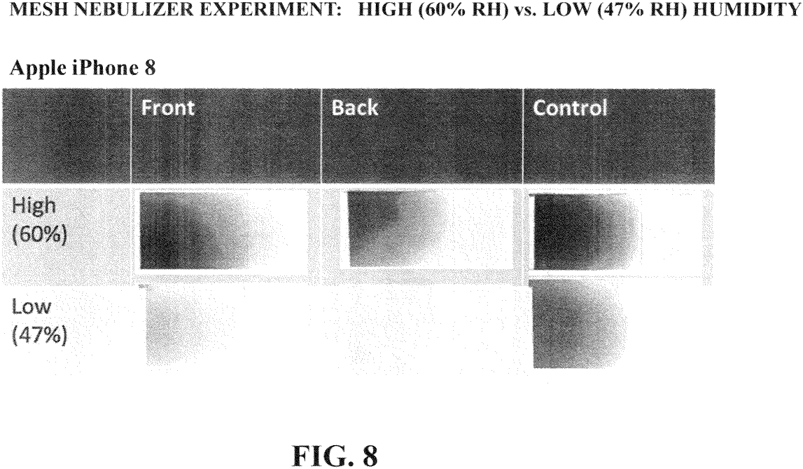

Similar testing was performed at higher relative humidity closer to ~60% RH with the Apple iPhone 8. These results are shown in FIG. 8. At higher relative humidity, the mobile phone 200 is in a favorable condition, as both the charge on the mobile phone 200 surface and the charge of the aerosol particles are neutralized by the moisture content in the air, thereby eliminating any possibility of electrostatic interactions. For the Control samples, there is no electrostatic surface charge either at low or high relative humidity; therefore, both control samples—low and high humidity—behaved similarly.

In some embodiments, such as shown in FIG. 6, a mobile device is modified with one or more Faraday shields 520 and one or more electrostatic films 510 by applying these to a mobile device to nullify the DC electrostatic fields. Various electrostatic shielding devices and methods may be used to reduce the likelihood that a mobile device will accumulate virus or other contaminants. If a mobile phone 200 is plugged into a mobile phone wall charger 400, the mobile phone 200 emanates these AC electric fields and, therefore, may be more likely to accumulate or disperse virus, whereas a battery-powered or unplugged mobile phone 200 emanates virtually no such AC field and, therefore, will accumulate little or no virus due to electrostatic attraction. As a result, changes to one or more of the circuits of the mobile phone wall charger 400 may reduce the degree to which the mobile phone 200 interacts with electrically charged aerosols.

In some embodiments, the mobile phone wall charger 400 utilizes Earth ground 420 as shown in FIG. 8 to assist the electronic filtering circuit.

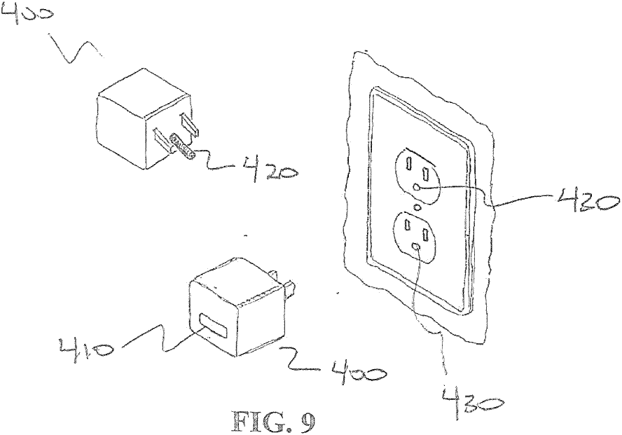

In some embodiments, some portion of the capacitive touchscreen is connected to electrical Earth ground 420 via the mobile phone case 500 of FIG. 6, charging cable and mobile phone wall charger 400 which has an Earth ground plug 420 as shown in FIG. 9.

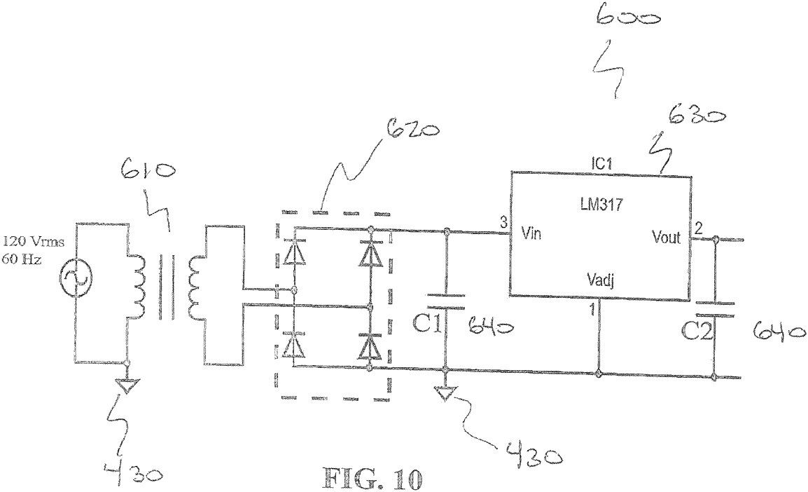

Various embodiments may include modifications to a mobile phone wall charger 400, a mobile phone case 500, a charging cable, and a mobile device or display alone or in combination. In some embodiments, a mobile phone wall charger 400 may be configured with reduced AC harmonics such as sawtooth wave spectra. In various embodiments, electrical components may be used with or in a given mobile phone 200, mobile phone wall charger 400, or cable to reduce harmonics and reduce the emanating AC electric field levels such that interaction with electrically charged aerosols is reduced. In some embodiments, a mobile phone wall charger 400 may include a bridge rectifier 620. Such a device charger can be modified by including a linear regulator 630 as shown in FIG. 10.

Additionally, in some embodiments, modifying the bridge rectifier 620 as shown in FIG. 10, which normally has four (4) diodes, by either adding additional diodes or installing Zener diodes 710 as replacements for one or more of the four diodes or as additional diodes is also within the scope of the disclosure for various embodiments. In addition, in some embodiments a capacitor C2 420 may also be added and in electronic communication with a bridge-rectifier 620 or a bridge-rectifier 620 with more than four diodes or a bridge-rectifier 620 that includes one or more Zener diodes 710.

Additionally, in some embodiments a mobile phone case 500 as depicted in FIG. 6. may be configured to include both the shielding materials, particularly the Faraday shield 520 on the back side of the mobile phone 200, and also a signal conditioner configured to smooth out the incoming 5 V signal before going into the mobile phone 200 to charge its battery. The signal conditioner may include one or more linear regulators 630 or diodes, including a Zener diode 710, or combinations of both.

Typically, if the thickness of a material is less than 3 or 4 skin depths of a material at a given frequency, that material will not shield the incoming signal, thereby enabling wireless charging. In various embodiments, one or more layers or components of the case have a thickness that is less than 3 or 4 skin depths of the selected conductive material.

For example, assuming a wireless charging frequency in the 50-150 kHz range, for aluminum foil, the corresponding electromagnetic skin depth is 212 micron, or approximately 0.008 inches, or 8 mil.

In some embodiments, aluminized Mylar is a preferred candidate material for the Faraday shield 520, as it contains a thin aluminum plating, typically having an aluminum plating thickness of 2-3 microns. Wireless charging through the aluminized Mylar foil was confirmed in experiments by placing a sheet of aluminized Mylar between a wireless charging pad 800 and mobile phone 200 and confirming wireless charging, whereas thicker metallic sheets proved to intercept the wireless charge by eddy current screening, thereby eliminating the wireless charging capability.

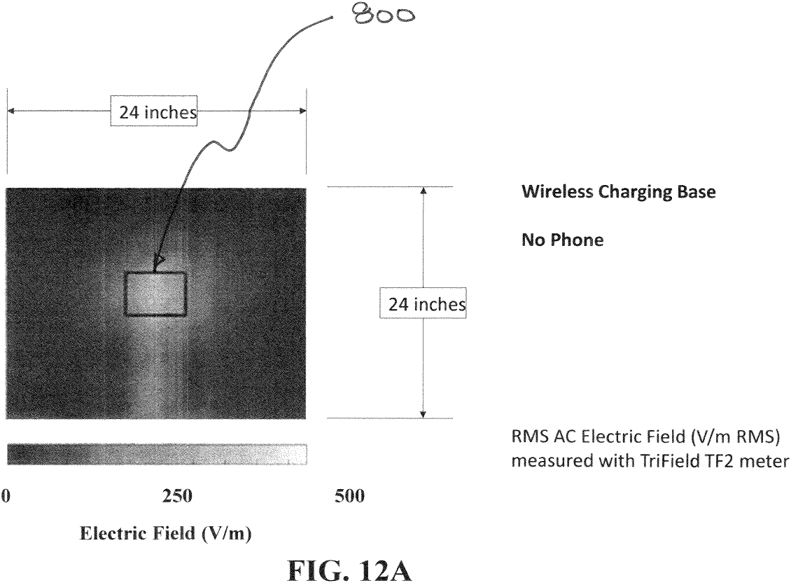

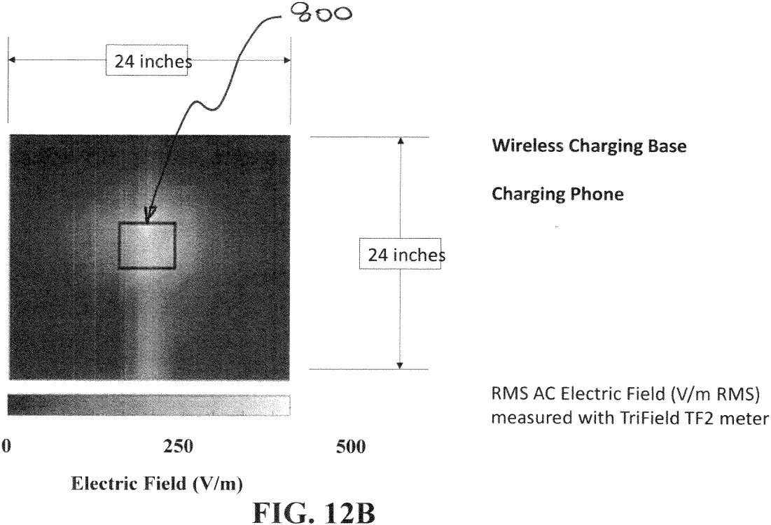

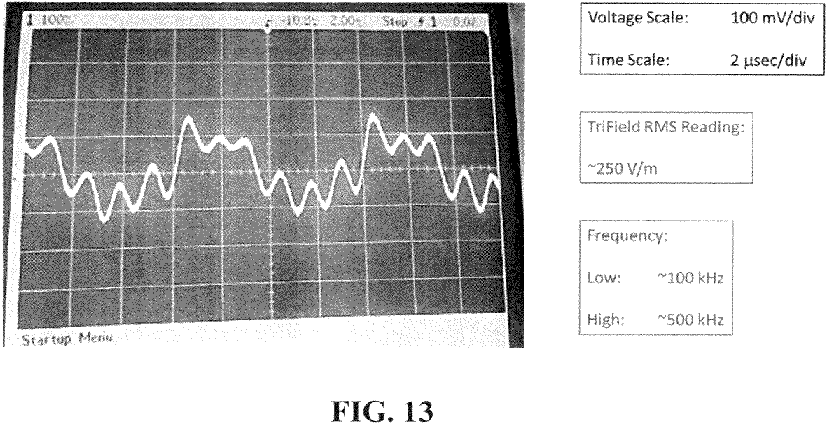

In addition, field measurements were made using the TriField EMF meter (model TF2) in the vicinity of a wireless charging pad 800 with and without a mobile phone 200 in FIG. 12A and FIG. 12B, respectively, also show AC electric fields on the order of ~500 V/m RMS. Using a simple pick-up coil that the charging conditions typically had a 50-100 kHz periodic component as shown in FIG. 13, which is within the frequency range of the TriField TF2 measuring device, which has a specified frequency response of 40 Hz to 100 kHz.

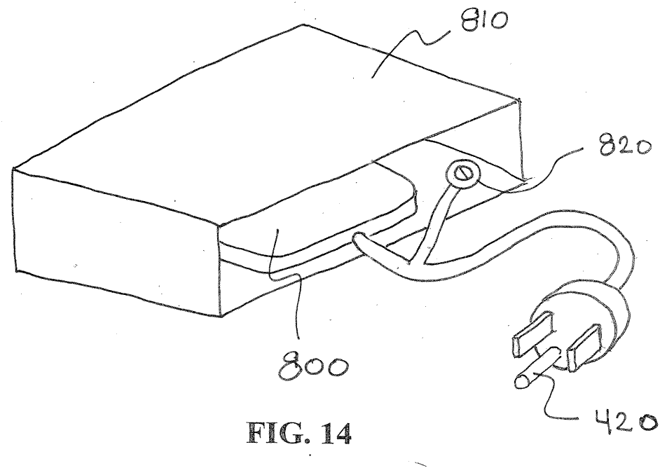

In some embodiments, as depicted in FIG. 14 it is preferable to use a Faraday enclosure 810 to either partially or completely surround the wireless charging pad 800. A passive shield with thickness equal to 3 or 4 electromagnetic skin depths should completely block the AC electric field emanating from either the wireless charging pad 800, wireless-charging mobile phone 200 or both.

In some embodiments, as also depicted in FIG. 14, it is preferable to connect the Faraday enclosure 810 using and Earth ground shield connection 820, which is either partially or completely surrounding the wireless charging pad 800, to electrical Earth ground 430 to aid in the shielding effectiveness. This Earth ground connection 430 is facilitated by the Earth ground plug 420, which is typically not used on most, if not all, wireless charging bases or mobile phone chargers.

In other embodiments, a signal conditioner may be incorporated in or otherwise function in electronic communication with a mobile device to provide the field regulation or reducing features disclosed herein.

The processes associated with the present embodiments may be executed by ASICs FPGAs, circuits, filters, signal and noise conditioners, signal generators, analog devices, digital devices or programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

In various embodiments of the present disclosure, a single component may be replaced by multiple components, and multiple components may be replaced by a single component, to perform a given function or functions. Except where such substitution would not be operative to practice embodiments of the present disclosure, such substitution is within the scope of the present disclosure.

Implementations of the present disclosure and all of the functional operations provided herein can be realized in analog circuitry, in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by or to control the operation of a data processing apparatus.

The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol Stack, a database management system, an operating system, or a combination of one or more of them.

The processes, filtering, signal processing and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

A computer or computing device can include machine-readable medium or other memory that includes one or more software modules for displaying a graphical user interface. A computer or computing device can also be headless. A computing device can exchange data such as monitoring data or other data using a network, which can include one or more wired, optical, wireless or other data exchange connections. A computing device or computer may include a server computer, a client user computer, a personal computer (PC), a laptop computer, a tablet PC, a desktop computer, a control system, a microprocessor, or any computing device capable of executing a set of instructions (sequential or otherwise) that specify actions to be taken by that computing device.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” or “approximately” “substantially” is before a quantitative value, the present teachings also include the specific quantitative value itself, unless specifically stated otherwise. As used herein, the term “about” refers to a ±10% variation from the nominal value. As used herein, the term “approximately” refers to a ±10% variation from the nominal value. As used herein, the term “substantially” refers to a ±10% variation from a nominal value or measured state, such as a state of focus or coincidence.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the disclosure as if each value were specifically enumerated therein. In addition, smaller ranges between and including the upper and lower limits of a given range are contemplated and encompassed within the disclosure. The listing of exemplary values or ranges is not a disclaimer of other values or ranges between and including the upper and lower limits of a given range.

Whether or not modified by the term “about” or “substantially,” identical quantitative values recited in the claims include equivalents to the recited values, e.g., variations in the numerical quantity of such values that can occur, but would be recognized to be equivalents by a person skilled in the art.

The use of headings and sections in the application is not meant to limit the disclosure; each section can apply to any aspect, embodiment, or feature of the disclosure. Only those claims which use the words “means for” are intended to be interpreted under 35 USC 112, sixth paragraph. Absent a recital of “means for” in the claims, such claims should not be construed under 35 USC 112. Limitations from the specification are not intended to be read into any claims, unless such limitations are expressly included in the claims.

When values or ranges of values are given, each value and the end points of a given range and the values there between may be increased or decreased by 20%, while still staying within the teachings of the disclosure, unless some different range is specifically mentioned.

It is to be understood that the figures and descriptions of the disclosure have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the disclosure, a single component may be replaced by multiple components, and multiple components may be replaced by a single component, to provide an element or structure or to perform a given function or functions. Except where such substitution would not be operative to practice certain embodiments of the disclosure, such substitution is considered within the scope of the disclosure.

The examples presented herein are intended to illustrate potential and specific implementations of the disclosure. It can be appreciated that the examples are intended primarily for purposes of illustration of the disclosure for those skilled in the art. There may be variations to these diagrams or the operations described herein without departing from the spirit of the disclosure. For instance, in certain cases, method steps or operations may be performed or executed in differing order, or operations may be added, deleted, or modified.

### REFERENCES CITED

W. Glover and H-K. Chan, Electrostatic charge characterization of pharmaceutical aerosols using electrical low-pressure impaction (ELPI), Journal of Aerosol Science 35 (2004) 755-764, https://doi.org/10.1016/j.jaerosci.2003.12.003.

P. Kwok et al., Electrostatic Charge Characteristics of Jet Nebulized Aerosols, Journal of Aerosol Medicine and Pulmonary Drug Delivery, 23 (3) (2010) 149-159, https://doi.org/10.1089/jamp.2009.0795.

E-M. Fong, W-Y. Chung, A Hygroscopic Sensor Electrode for Fast Stabilized Non-Contact ECG Signal Acquisition, Sensors 15 (2015) 19237-19250, https://doi.org/10.3390/s150819237.

M. Manolica and I. Chapalo, Surface Resistivity Measurements of Electrostatic Discharge Protective Materials for Different Relative Humidity Levels, BULETINUL INSTITUTULUI POLITEHNIC DIN IAŞI Publicat de Universitatea Tehnicǎ, Gheorghe Asachi″ din Iaşi Tomul LVII (LXI), Fasc. 1, 2011 Secţia ELECTROTEHNICǍ. ENERGETICǍ. ELECTRONICǍ.

J. Hautanen et al., Electrical Agglomeration of Aerosol Particles in an Alternating Electric Field, Aerosol Science and Technology, 22 (2) (1993) 181-199, https://doi.org/10.1080/02786829408959739.

B. Eliasson et. al., Coagulation of Bipolarly Charged Aerosols in a Stack Coagulator, Aerosol Science, 18 (6) (1987) 869-872.

E. Fleck and B. Eliasson, “An Ion Source for Unipolar Charging of Particles in an AC-Field,” Journal of Aerosol Science, 18 (6) (1987) 769-771.

T. Watanabe et. al., Submicron particle agglomeration by an electrostatic agglomerator, Journal of Electrostatics, 34 (1995) 367-383.

L. Golshahi et. al., Production of Highly Charged Pharmaceutical Aerosols Using a New Aerosol Induction Charger, Pharmaceutical Research, 32 (9) (2015), 3007-3017.

What is claimed is:

1. An electrical device charger optimized such that the resulting maximum value of AC electric field measured on the surface of the electrical device during charging is less than 100 V/m RMS measured with a TriField TF2 electric field meter.

2. The electrical device charger of claim 1 wherein the charger comprises a bridge rectifier, linear regulator and an output tuning capacitor, wherein the bridge rectifier, linear regulator and output tuning capacitor tune the voltage output signal used to charge the electrical device.

3. The electrical device charger of claim 1 wherein the device is a mobile phone.

4. The electrical device charger of claim 1 wherein the electrical device is a capacitive touchscreen.

5. The electrical device charger of claim 1 wherein a bridge rectifier comprising more than four diodes is used.

6. The electrical device charger of claim 1 wherein a linear regulator, selected from a group consisting of a filter, one or more diodes, a noise conditioner, a resistor, a capacitor, an inductor, and combinations thereof, is used.

7. The electrical device charger of claim 1 wherein a linear regulator comprising one or more Zener diode is used.

8. The electrical device charger of claim 1 wherein a connection to electrical Earth ground is utilized.

9. The electrical device charger of claim 1 optimized such that the resulting maximum value of AC electric field measured on the surface of the electrical device during charging is less than 20 V/m RMS measured with a TriField TF2 electric field meter.

10. A mobile phone case optimized to minimize the total DC electrostatic surface charge on a mobile phone.

11. The mobile phone case of claim 10 wherein the mobile phone case comprises an electrostatic film and a Faraday shield.

12. The mobile phone case of claim 10 wherein an electrostatic film, selected from the group consisting of a vinyl film, a silica film, a polymer film, a doped film or other films that are generally negative on the triboelectric scale, is used.

13. The mobile phone case of claim 10 wherein an electrostatic films, elected from the group of electrostatic dissipating materials, is used.

14. The mobile phone case of claim 10 wherein the mobile phone case is fabricated from the group of electrostatic dissipating materials.

15. The mobile phone case of claim 10 wherein a Faraday shield, comprising a mesh or a sheet, wherein the mesh or sheet is sized, positioned, and configured to reduce a DC electrostatic field from one or more surfaces of a housing of a mobile device comprising a display screen and the housing, wherein thickness of the conductor is selected to permit wireless charging through back surface of the housing, is used.

16. The mobile phone case of claim 10 wherein a connection to Earth ground is utilized such that the resulting maximum AC electric field measured on the surface of the mobile phone, while the mobile phone is charging on an electrical device charger, is less than 100 V/m RMS measured with a TriField TF2 electric field meter on the surface of the phone.

17. A wireless charging pad incorporating a Faraday enclosure designed to reduce the maximum AC electric field measured on the outer surface of the Faraday enclosure to less than 100 V/m RMS measured with a TriField TF2 electric field meter.

18. The wireless charging pad of claim 17 wherein the Faraday enclosure is connected to electrical Earth ground.

19. A mobile phone comprising some elements of the foregoing claims such that resulting maximum value of the AC electric field measured on the surface of the mobile phone, while the mobile phone is charging on an electrical device charger, is less than 100 V/m RMS measured with a TriField TF2 electric field meter.

20. The mobile phone of claim 19 optimized such that the resulting maximum value of the AC electric field measured on the surface of the mobile phone, while the mobile phone is charging on an electrical device charger, is less than 20 V/m RMS measured with a TriField TF2 electric field meter.
